(19) United States
(12) Patent Application Publication
(10) Pub. No.: US 2012/0088696 A1
(43) Pub. Date: Apr. 12, 2012

(54) MICRO ELECTROCHEMICAL MULTIPLEX REAL-TIME PCR PLATFORM

(76) Inventors: Yi-Chiuen HU, Hsinchu City (TW); Jui-Yu Wu, Hsinchu City (TW); Jun-Sheng Wang, Hsinchu City (TW); Tsung-Tao Huang, Hsinchu City (TW); Chih-Sheng Yu, Hsinchu City (TW)

(21) Appl. No.: 13/163,855

(22) Filed: Jun. 20, 2011

(30) Foreign Application Priority Data
Oct. 8, 2010 (TW) 099134467

(51) Int. Cl. C40B 60/12

(52) U.S. Cl. 506/39

(57) ABSTRACT

A micro electrochemical multiplex Real-Time PCR platform which can be widely used to rapidly amplify, examine, and quantify target nucleotides in real-time, and can be used in sepsis diagnosis, rapid detection of animal/plant viral or bacterial infections, plant disease control, real-time environmental monitoring, food industry contamination prevention, and improvement of agricultural varieties.

### CROSS REFERENCE TO RELATED APPLICATIONS

This application claims priority of Application No. 099134467 filed in Taiwan, R.O.C. on Oct. 8, 2010 under 35 U.S.C. §119, the entire contents of which are hereby incorporated by reference.

### FIELD OF THE INVENTION

The present invention relates to a novel micro electrochemical multiplex Real-Time PCR platform which can be broadly used to rapidly amplify, examine and quantify the target nucleotides in real-time and can be used in not only sepsis diagnosis, but rapid detection of animal/plant viral or bacterial infection, plant disease control, real-time environmental monitoring, food industry contamination prevention, or improvement of agricultural varieties, etc.

### BACKGROUND OF THE INVENTION

British scientists, James D. Watson, Francis H. Crick, and Rosalind E. Franklin, published the double-helix model of DNA structure in the journal Nature in 1953, and consequently opened a new era in molecular biology and genetics. The knowledge of how nucleotides are arranged and bound with each other has broadened the research and applications of molecular biology, and gradually shaped and defined the process of replication and reproduction of genetic materials.

An important step in molecular biology techniques for manipulating gene rearrangement or protein expression is to rapidly replicate the target DNA in vast amounts, and only when the concentration of DNA reaches a certain amount is the research valuable. Hence, polymerase chain reaction (PCR) is the most well-known technique for DNA amplification. At present, PCR is widely used in paternity identification, food industry, agricultural variety improvement, genome map establishment, gene rearrangement techniques, evolution, genetics, and environmental monitoring, etc. In addition, a major contribution of the technique, PCR, is replication of DNA fragments in vast amount in vitro, which facilitates the advancement of molecular biology techniques. Subsequently, the inventor of this technique, Kary Mullis, was awarded the Nobel Prize in Chemistry in 1993.

Traditional Real-Time Polymerase Chain Reaction (RT-PCR)

The DNA fragments synthesized after traditional PCR amplification were usually subjected to agarose gel electrophoresis using ethidium bromide (EtBr) as the DNA intercalating agent. However, EtBr is very volatile and has been classified as a carcinogen by the US government. Hence, this method raises contamination and biohazard concerns. Moreover, the agarose gel electrophoresis used to analyze the end product of PCR is a qualitative analysis. The intensity of the band on the image, as calculated by computer software, is only semi-quantitative and is not completely accurate. Although the high efficiency electrophoresis apparatus currently available on the market has been improved dramatically so as to overcome problems encountered in traditional agarose gel electrophoresis, e.g. contamination of EtBr and time-consuming process of the analysis, etc., gel electrophoresis remains a method of analyzing the end product of PCR and cannot provide real-time quantitative information

In order to study the accurate and precise relationship of the concentrations of PCR products and the cycles of reactions, Quantitative real-time PCR (qPCR) was developed. The principle of quantitative real-time PCR is adding fluorescent materials to the reaction mixture, whereby target DNA concentration increases exponentially along with the reaction cycles. The fluorescent material binds to the DNA and produces a fluorescent signal which can be detected by a specific instrument and analyzed by computer software so as to obtain a relative diagram. The DNA binding dyes intercalate into DNA and produce fluorescence. SYBR-Green, for example, only exhibits weak background fluorescence in its free state. Once intercalated into the minor groove of the double-stranded DNA, it will be excited and produces a strong fluorescence signal which is suitable for monitoring the concentration of double-stranded DNA during the PCR process.

It is evident that real-time PCR can accurately quantify the initial concentration of target DNA and is particularly useful in plant disease control for development of disease-resistant varieties and in testing imported agricultural products. On the other hand, traditional PCR can only be used for identification, and is at most semi-quantitative. Applications of real-time PCR in plant disease control have increased significantly. At present, for plant infectious diseases, e.g. Phytophthora infestans, Tomato spotted wilt virus, Xylella fastidiosa, Ralstonia solanacearum (race 3, biovar 2), and Candidatus Liberbacter spp. etc. can be detected by real-time PCR as well as pest detection of Lepidoptera orana insects, fruit flies and South yellow thrips, etc. Nonetheless, real-time PCR using fluorescence costs relatively more in instruments and supplies than traditional PCR, and is therefore less popular.

In another aspect, application of real-time quantitative nucleic acid amplification technology in diagnosis of infectious diseases has become a major task in present medical development. For example, Sepsis is the top leading infectious disease in non-cardiac ICU hospitalized patients worldwide, and over 750,000 cases are reported every year in the U.S.A. This means that 2,000 new patients are diagnosed with sepsis every day. According to the recent statistics, sepsis has become one of the top ten leading causes of death in Taipei City since 2007, with a mortality rate of around 27-50%. In addition, due to the increasing elderly population in Taiwan, wide applications of immunosuppressant and invasive treatments, as well as drug-resistant bacteria caused by antibiotic abuse, the cases of sepsis have increased noticeably. Furthermore, the cost to treat sepsis is far more expensive in terms of medical resources and costs nearly 200 million US dollars and 500 million Euros in the U.S.A. and Germany, respectively. As a result, physicians and health insurance companies have been searching for tests that provide early detection and accurate diagnosis of sepsis. Currently, the standard method to detect sepsis is blood culture. However, blood culture requires expansive, large-scale instruments, experienced physicians, and a considerable amount of relevant supplies. Most importantly, a bacterial culture can take 4 to 9 days to provide. During this period of time, physicians can only rely on their past experiences to treat sepsis. A common treatment is empirical antimicrobials. In the event that bacteria-caused sepsis if confirmed, identification of the Gram (+) or Gram (−) bacteria and quantitation of the pathogen are necessary for proper antibiotic treatments. Currently, no instruments are available which are easy to operate, can simultaneously provide information of antibiotic resistance and accurate quantitation of blood bacteria for rapid detection of the pathogen within 4 hrs.

Newly developed relative techniques for pathogen detection include:

1. Tissari et al. published a prove-it sepsis assay by using microarray (MOBIDIAG, Finland) and obtained the signals after polymerization. Nevertheless, the entire process takes roughly 18 hrs and bacterial concentration in the blood was not quantified. Consequently, physicians cannot determine the dosage of antibiotics used for treatment.

2. Kriegner et al. also published a modified traditional PCR method by using multiplex 16S rDNA as the primer. This process takes only 6 hrs, but requires DNA sequencing for detection of the pathogens (SepsiTest™, Molzym, Germany) which is more complicated, and bacteria quantitation was also not available.

3. Traditional fluorescence Real-Time PCR system is complicated and expensive. Moreover, the kits are purchased from foreign manufacturers and usually cost upwards of two million dollars. Thus, the popularity of these systems is restricted.

The present invention provides a micro electrochemical multiplex Real-Time PCR platform which is a cost-effective electrochemical Real-Time PCR and is small, easy to use, and can be used to develop detection kits that are specific to local needs. Electrochemical Real-Time PCR platform can calculate the sample concentration according to the reaction curve as the DNA is amplified during the PCR process. Thus, suspicious sepsis patients can be confirmed of their diagnosis and receive proper antibiotic treatment within 6 hrs after arriving at the hospital and physicians can begin the antibiotic treatment immediately after confirmation of diagnosis. In addition, during the treatment, antibiotic dosage can be adjusted accordingly by re-testing with the same kit, and patients can avoid extended hospitalization and be discharged when the blood bacteria concentration reaches zero. Therefore, the platform can significantly reduce the mortality of sepsis and allow more efficient allocation of medical resources. The present invention can be broadly used in rapid nucleotide amplification, real-time detection, and accurate quantitation. Aside from sepsis detection, this platform also provides rapid detection of animal/plant viral or bacterial infection, e.g. viral infections in fish or shrimp breeding, avian influenza, enterovirus infection, H1N1 infection, and super bacteria carrying NDM-1 gene, etc. Moreover, this platform can also be used for plant disease control, real-time environmental monitoring, food industry contamination prevention, or improvement of agricultural varieties, etc.

Given the above, after years of painstaking research and taking the applications of Real-Time PCR in clinical diagnosis and rapid detection of animal/plant viral or bacterial infections into consideration, the inventor(s) have improved the disadvantages of regular Real-Time PCR and finally, successfully developed a novel micro electrochemical multiplex Real-Time PCR platform.

### BRIEF SUMMARY OF THE INVENTION

The present invention features a novel micro electrochemical multiplex real-time PCR platform that can rapidly amplify and quantify a target DNA.

In one aspect, the invention provides a multiplex real time PCR platform which can detect the type of bacteria that causes sepsis and its related concentration so as to assist in clinical diagnosis and monitoring.

To accomplish these aims, the present invention establishes an electrochemical multiplex real time PCR platform by using electro-active DNA intercalating dyes and obtaining a relationship curve of reaction time and the concentrations of DNA. Furthermore, application of the disposable micro porous electrode chip allows the integration of the electrodes and PCR mixtures in a flat chip which can process 8 to 96 PCR samples simultaneously and quantify the electrochemical signals in real-time. The required sample volume is only 1-10 μL. The reaction chip is very cost-effective and is disposable, thereby providing a lower risk of cross-contamination.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing the micro electrochemical multiplex real time PCR platform.

FIG. 2 shows a micro porous electrode chip.

FIG. 3 is a diagram of Methylene Blue (MB) binding to the double-helix DNA (dsDNA). Each black object denotes a Methylene Blue molecule.

FIG. 4 is a diagram demonstrating that a Methylene Blue electro-signal decreases along with an increasing concentration of double-helix DNA

FIG. 5 is a flow chart of a clinical application of the micro electrochemical multiplex real time PCR platform. The electro-signal of Methylene Blue decreases along with an increasing concentration of double-helix DNA. The X axis is voltage (V), and the Y axis is current (amps).

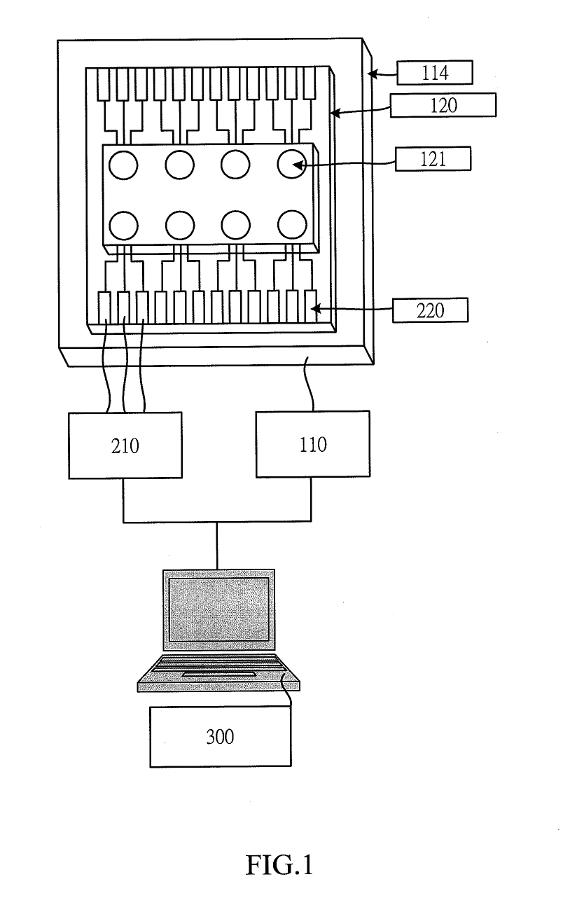

### DETAILED DESCRIPTION OF THE PREFERRED EMBODIMENTS

The present invention will now be described more specifically with reference to the following embodiments, which are provided for the purpose of demonstration rather than limitations.

### Example 1

According to the present invention, the novel micro electrochemical multiplex Real-Time PCR platform consists of following three parts. First, an electrochemical real-time PCR reaction system is provided which includes a PCR temperature control module (110) that the system uses to adjust the temperature of the reaction chip (120). The sample is mixed with one type of the DNA binding dyes and placed on the reaction chamber in PCR reaction chip (120) for PCR reaction, and said PCR reaction chamber (121) can be a circular structure, an enclosed structure, a liquid bead or a liquid bead coated with oil film, etc. Second, an electrochemical detection system which includes an electrochemical detection module (210) and electrodes (220) detects the electrochemical changes in the reaction solution with electrodes (220). Finally, the user interface system (300) is integrated and the DNA concentration of the test sample is quantified by specific software installed in the system.

Real-time quantitative PCR is a major tool recognized for examining various infectious diseases. The present invention, a novel micro electrochemical multiplex Real-Time PCR platform, is superior than the traditional PCR methods in that it can rapidly detect the sample, it is cost-effective, small, and easy to use, and, most importantly, the platform can be used for development of various detection kits for unique local needs. Said system includes:

An electrochemical real-time PCR reaction system, having:

(1) A PCR temperature control module (110), for rapidly and accurately controlling the heating plate (111) by using thermoelectric cooling modules, TE Cooler, along with a single microchip controller and driving circuit.

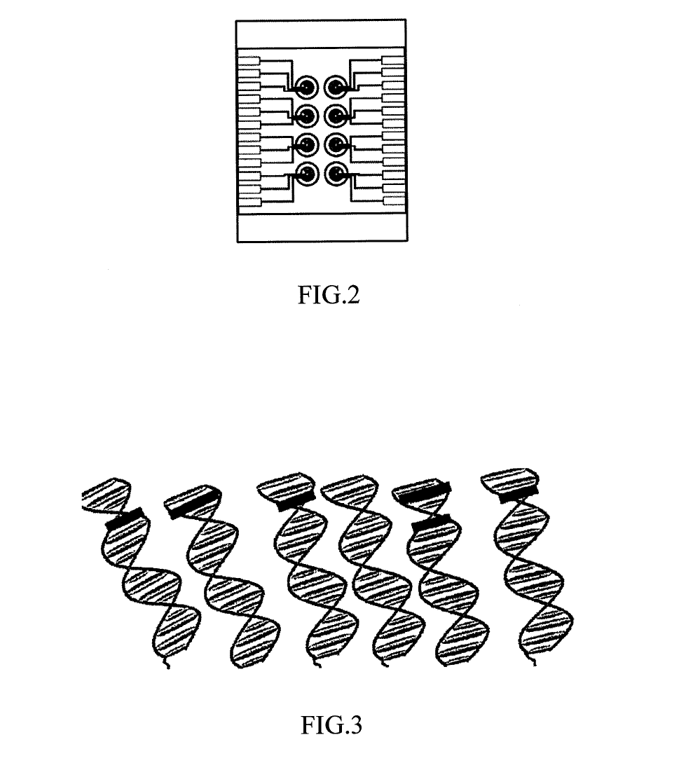

(2) A PCR reaction chip (120), said PCR reaction chip being a disposable micro porous electrode chip (FIG. 2). PCR reaction and electrodes are integrated into one flat chip which can process 8 to 96 PCR samples simultaneously and quantify the electrochemical signals in real-time. The required sample volume is only 1-10 μL. The reaction chip is very cost-effective and is disposable, hence, providing a lower risk of cross-contamination.

Second, a electrochemical monitoring system, in which:

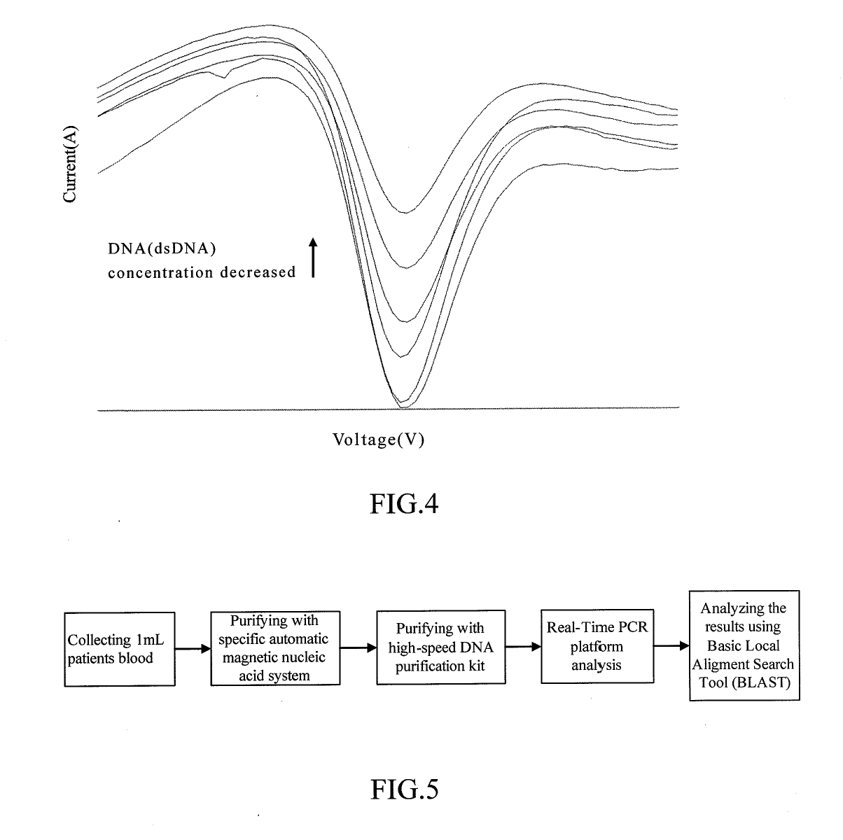

After mixed with the electro-active DNA binding dye, the test sample is placed on the PCR reaction chamber (121) in a PCR reaction chip for PCR reaction. The more nucleic acid molecules which are synthesized, the more electro-active molecules are bound to DNA. The electro-active DNA binding dyes are positively-charged organic molecules that can selectively bind to double-helix DNA (dsDNA) and include Methylene Blue (MB), ethidium bromide, anticancer agent, organic dye, metal complex etc. As shown in FIG. 3, MB has high oxidation-reduction potential; when bound to dsDNA, the oxidation potential will reduce. Therefore, the signal change detected by the electrodes (220) and the calculation made by the electrochemical detection module (210) allow the measurement of the concentration of dsDNA (FIG. 4).

Third, user interface system is provided, in which:

During the process of polymerase chain reaction (PCR), the user interface system can be used to control the reaction temperature and to detect the concentration of nucleic acids. Furthermore, the DNA quantitation software installed in the system can measure the concentrations of the test samples.

### Example 2

The present invention uses the rapid Real-time PCR test for sepsis as an example and demonstrates the application process of the novel micro electrochemical multiplex Real-Time PCR platform in clinical diagnosis. As shown in FIG. 5, 1 mL of a patient's blood sample is collected and then purified with a specific automatic magnetic nucleic acid purification system. After purification, the genomic nucleic acids are further purified with a high-speed DNA purification kit and the resulting nucleic acids are used as the templates for a PCR reaction followed by designing new and highly specific primers based on the DNA fingerprints (e.g. Gram-negative, Gram-positive, and fungus) of the bacteria that causes sepsis for a micro electrochemical multiplex Real-Time PCR platform analysis. Real-time PCR reaction mixture is prepared in a test tube by adding forward and reverse primers, 10×PCR buffer, dNTPs, ddH₂O, Taq DNA polymerase, electro-active material, and finally, the purified nucleic acids as the template. The mixture is mixed thoroughly, and 5-40 μL of the mixture is transferred to the reaction chamber in a real-time reaction chip. The PCR reaction is set at 20-30 cycles and the oxidation-reduction electrical signal is monitored in real-time. The DNA quantitation software is used to transform the electrical signal into DNA concentration, and the test results are analyzed using Basic Local Alignment Search Tool (BLAST) so as to confirm the pathogen species and pathogen concentration in patient's blood. These results provide important information which allows accurate prescription and dosage determination.

The foregoing detailed descriptions are practical examples of the present invention, it should be noted, however, that such examples are provided for the purposes of demonstration rather than limitation. Application of said micro electrochemical multiplex Real-Time PCR platform in paternity identification, food industry, improvement of agricultural varieties, establishment of genome, gene recombination technology, environmental monitoring, plant disease control and clinical infectious disease monitoring, etc. are all included in the present invention.

Many changes and modifications in the above described embodiments of the invention can, evidently, be carried out without departing from the scope thereof. Accordingly, to promote the progress in science and the useful arts, the invention is disclosed and is intended to be limited only by the scope of the appended claims.

What is claim is:

1. A micro electrochemical multiplex Real-Time polymerase chain reaction (PCR) platform, comprising:
an electrochemical real-time PCR reaction system including a PCR temperature control module, a PCR reaction chip, and a PCR reaction chamber, the PCR temperature control module being used to adjust a temperature of the PCR reaction chip, wherein samples are mixed with one type of DNA binding dye and placed on the PCR reaction chamber in the PCR reaction chip to obtain a PCR reaction, and
an electrochemical detection system including an electrochemical detection module and at least one one electrode, the electrochemical detecting system measuring the lost or reduced electro-activity of an electro-active material after the electro-active material binds to double-stranded DNA (dsDNA), the electrochemical signal detected in the chip being used to identify different DNAs and their concentrations; and
wherein the PCR reaction chamber is located in the PCR reaction chip, allowing the same electrode to quantify samples after each replication cycle in real-time.

2. The micro electrochemical multiplex Real-Time PCR platform of claim 1, wherein the PCR reaction chip is a disposable micro porous electrode chip.

3. The micro electrochemical multiplex Real-Time PCR platform of claim 1, wherein the electrochemical detection module is composed of at least one set, each set comprising two or three electrodes.

4. The micro electrochemical multiplex Real-Time PCR platform of claim 1, wherein the electro-active materials are Methylene Blue, ethidium bromide, anticancer agents, organic dyes, or metal complexes, and can bind to dsDNA.

5. The micro electrochemical multiplex Real-Time PCR platform of claim 1, wherein the PCR reaction chamber is a circular structure in the electrochemical chip.

6. The micro electrochemical multiplex Real-Time PCR platform of claim 1, wherein the PCR reaction chamber is an enclosed structure that covers the electrochemical chip.

7. The micro electrochemical multiplex Real-Time PCR platform of claim 1, wherein the PCR reaction chamber is a liquid bead or a liquid bead coated with oil film.

8. The micro electrochemical multiplex Real-Time PCR platform of claim 1, wherein the platform is controlled by a user interface system and said user interface system includes DNA quantitation software.

9. The micro electrochemical multiplex Real-Time PCR platform of claim 1, wherein the platform can be used in paternity identification, food industry, improvement of agricultural varieties, establishment of genome maps, gene rearrangement techniques, environmental monitoring, plant disease control, and clinical infectious disease monitoring.

10. The micro electrochemical multiplex Real-Time PCR platform of claim 9, wherein the platform can be used for rapid quantitation and diagnosis of clinical infectious disease.
